(19) United States
(12) Patent Application Publication
(10) Pub. No.: US 2005/0063564 A1
(43) Pub. Date: Mar. 24, 2005

(54) Hand pattern switch device

(76) Inventors: Keiichi Yamamoto, Tokyo (JP); Hiromitsu Sato, Tokyo (JP); Shinji Ozawa, Yokohama-shi (JP); Hideo Saito, Yokohama-shi (JP); Hiroya Igarashi, Yokohama-shi (JP)

Correspondence Address: ROSSI & ASSOCIATES, P.O. BOX 826, ASHBURN, VA, 20146-0826, US

(21) Appl. No.: 10/915,952

(22) Filed: Aug. 11, 2004

(30) Foreign Application Priority Data
Aug. 11, 2003 (JP) 2003-291380

(51) Int. Cl. G06K 9/00; G05D 1/00

(52) U.S. Cl. 382/104; 382/181; 701/1

(57) ABSTRACT

A hand pattern switch device capable of easily and reliably detecting a hand pattern or a palm motion of an operator. From a picked-up image of a distal arm, an axis passing through the centroid of a hand is determined as a central axis passing through the center of arm. At least either first scanning lines perpendicular to the central axis or second scanning lines extending along the central axis are set between a fingertip and a palm center. While changing the scanning line to be examined from the fingertip side toward the palm center, a determination is made to determine how many number of scanning lines for each of which a finger width equal to or larger than a predetermined width is detected are present, thereby making a detection of whether or not the finger is extended from the palm.

### CROSS-REFERENCE TO A RELATED APPLICATION

This nonprovisional application claims priority under 35 U.S.C. §119(a) on Patent Application No. 2003-291380 filed in Japan on Aug. 11, 2003, the entire contents of which are hereby incorporated by reference.

### BACKGROUND OF THE INVENTION

1. Technical Field

The present invention relates to a hand pattern switch device suitable for a driver to easily operate vehicle-mounted equipment such as air conditioner equipment and audio equipment and ancillary vehicle equipment such as side mirrors, without his/her driving being affected and without the need of touching an operation panel of the vehicle-mounted equipment.

2. Related Art

There has been proposed a technical art to operate vehicle-mounted equipment such as air conditioner equipment and audio equipment without touching an operation panel of the vehicle-mounted equipment, in which an image of a body part (for example, a left hand) of a driver is picked up by a camera and subject to pattern recognition to obtain information that is used to operate the vehicle-mounted equipment (refer for example to JP-A-11-134090). Another technical art has also been proposed that detects a driver's gesture such as hand pattern and hand motion, from which information used to operate vehicle-mounted equipment is acquired (refer for example to JP-A-2001-216069).

This kind of art, realized by the pattern recognition to recognize a hand pattern from a picked-up image of a hand or realized by the motion detection to detect a hand motion by tracing a positional change of a recognized hand, is called as a hand pattern switch device in the present specification for the sake of convenience.

In the case of using the hand pattern switch device in order to operate vehicle-mounted equipment, the pattern or motion of the driver's (operator's) hand must be detected reliably and accurately. To this end, it is necessary to accurately recognize which part of the picked-up image corresponds to the driver's (operator's) hand. However, the driver (operator) sometimes wears a long sleeve shirt, a wrist watch, or the like. In that case, a wrist portion in the input image is detected to be extraordinary large, or detected to be disconnected due to the presence of an image component corresponding to the wrist watch or the like. This results in the fear of a portion corresponding to the driver's palm or the back of his/her hand (hereinafter collectively referred to as palm) being unable to be detected with reliability, despite that such portion is to be detected for pattern recognition. In addition, the prior art poses a further problem of the processing load being increased, since it generally uses a complicated image processing technique, such as region segmentation, or a matching technique in which a predetermined standard hand pattern is referred to.

### SUMMARY OF THE INVENTION

The object of this invention is to provide a hand pattern switch device capable of easily and reliably detecting a hand pattern or a hand motion of a driver (operator) observed when the driver operates various vehicle-mounted equipment and ancillary vehicle equipment, thereby properly inputting information used for operations of these equipment.

According to this invention, there is provided a hand pattern switch device which has image pickup means for picking up an image of a distal arm that is within a predetermined image pickup zone and in which a hand pattern and/or a motion of a finger of a hand is detected from the image picked up by the image pickup means to obtain predetermined switch operation information. The hand pattern switch device comprises first image processing means for determining a central axis passing through a center of the arm based on the picked-up image, scanning line setting means for setting at least either a first scanning line extending perpendicular to the central axis or a second scanning line extending along the central axis, and determination means for determining whether or not any finger of the hand is extended based on the at least either the first or second scanning line set by the scanning line setting means.

### BRIEF DESCRIPTION OF THE DRAWINGS

The present invention will become more fully understood from the detailed description given herein below and the accompanying drawings which are given by way of illustration only, and thus, are not limitative of the present invention, and wherein:

FIG. 1 is a view showing the outline of structure of a hand pattern switch device according to an embodiment of this invention;

FIG. 2 is a view showing a hand/finger image pickup zone in the hand pattern switch device shown in FIG. 1;

FIG. 3 is a flowchart showing an example of processing procedures for recognition of hand pattern and palm center;

FIG. 4 is a conceptual view for explaining the processing for recognition of hand pattern and palm center shown in FIG. 3;

FIG. 5A is a view for explaining drawbacks of conventional typical processing for hand pattern recognition;

FIG. 5B is a view similar to FIG. 5A;

FIG. 6A is a view showing hand pattern 1 used in the embodiment of this invention;

FIG. 6B is a view showing hand pattern 2;

FIG. 6C is a view showing hand pattern 3;

FIG. 6D is a view showing hand pattern 4;

FIG. 7 is a flowchart showing an example of processing procedures for hand pattern recognition performed by an instructed-operation recognizing section in the hand pattern switch device shown in FIG. 1;

FIG. 8 is a flowchart showing an example of processing procedures for operation amount detection;

FIG. 9 is a flowchart showing an example of processing procedures for operation amount detection in a time mode;

FIG. 10 is a flowchart showing an example of processing procedures for operation amount detection in a distance/time mode;

FIG. 11 is a view showing input modes of inputting switch-operation information to the hand pattern switch device with use of hand/fingers; and

FIG. 12 is a view showing an example of systemized selection of controlled objects.

### DETAILED DESCRIPTION OF THE PREFERRED EMBODIMENTS

In the following, a hand pattern switch device according to an embodiment of this invention will be explained with reference to the drawings.

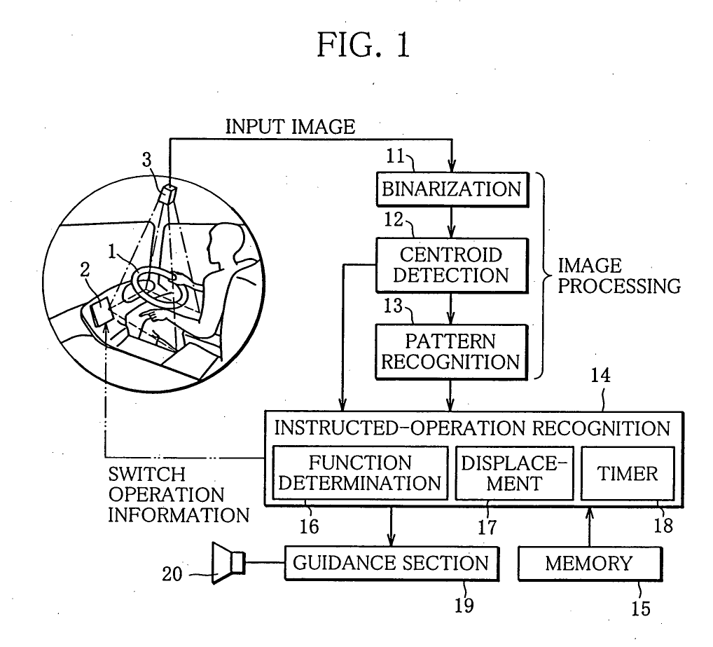

FIG. 1 is a view of a general construction of essential part of the hand pattern switch device according to the present embodiment, showing a state around a driver's seat of a vehicle and functions of the hand pattern switch device realized for example by a microcomputer (ECU) and the like. At the front of the driver's seat, a steering wheel 1 adapted to be steered by a driver, a combination switch (not shown), etc. are provided, whereas an operating section 2 for audio equipment, air conditioner equipment, etc. is provided on a console panel. At a ceiling located above the driver's seat, a video camera 3 is disposed for picking up an image of a hand of the driver who extends his/her arm to an image pickup zone located laterally to the steering wheel 1. The camera 3 is comprised of a small-sized CCD camera or the like. The camera 3 may be the one which obtains a visible light image under predetermined illumination (daytime). Of course, a so-called infrared camera which emits near-infrared light to the pickup zone to obtain an infrared image may be used, when the illumination for the pickup zone is insufficient, as in nighttime. To operate the hand pattern switch device, the hand pattern is changed by selectively flexing desired one or ones of the fingers, with the palm positioned horizontally in the pickup zone, and the palm position is displaced (moved) back and forth and left and right. Despite that an image of the back of hand is actually picked up by the camera 3, the term “palm” is used in the description here that represents not only the palm but also the back of hand whose image is to be picked up.

Basically, the hand pattern switch device performs the processing to recognize a driver's hand pattern or a hand motion on the basis of an image picked up by and input from the camera 3, and based on results of the recognition, acquires predetermined corresponding switch-operation information. Thus, the hand pattern switch device serves, instead of the operating section 2, to provide switch-operation information to the audio equipment, air conditioner equipment, etc. More specifically, the hand pattern switch device comprises a binarization processing section 11 for binarizing an input image picked up by the camera 3 so that background image components are removed to extract image components corresponding to the distal arm, mainly the palm and fingers of the hand, from the picked-up image; a centroid detecting section 12 for determining a centroid position of the hand based on the image of the palm and fingers of the hand extracted by the binarization processing; and a pattern recognition section 13 for recognizing a hand/finger pattern.

The hand pattern switch device further comprises an instructed-operation recognizing section 14 for recognizing a switch operation given by the driver by the hand pattern or hand motion, based on results of recognition performed by the pattern recognition section 13 and the centroid position of the hand detected by the centroid detecting section 12. This instructed-operation recognizing section 14 generally comprises a function determination section 16 for determining (identifying) a type of operation intended by the hand pattern recognized as mentioned above, referring to a relation between hand patterns registered beforehand in a memory 15 and their functions, a displacement detecting section 17 for tracing a motion of centroid position of palm with a particular finger pattern or a motion of fingertip to thereby detect a displacement thereof from its reference position, and a timer 18 for monitoring the palm motion or fingertip motion in terms of elapsed time during the palm or fingertip is moved. On the basis of results of determination and monitoring, the instructed-operation recognizing section 14 determines predetermined switch-operation information specified by the driver's hand pattern and palm motion, and outputs this switch-operation information by way of example to the audio equipment, air conditioner equipment, or the like.

The instructed-operation recognizing section 14 is further provided with a guidance section 19 that provides a predetermined guidance to the driver according to results of the aforementioned determination, etc. The driver is notified of the guidance form a speaker 20 in the form of a speech message that specifies for example the audio equipment or air conditioner equipment (controlled object equipment), or volume/channel setting, wind volume/temperature, or the like (controlled object function), or in the form of confirmation sound such as pip tone or beep tone that identifies a switch operation (operation amount) having been made. As for concrete operation modes of the instructed-operation recognizing section 14, i.e., control of output of switch-operation information in respect of controlled objects such as audio equipment, air conditioner equipment, and the like, explanations will be given later.

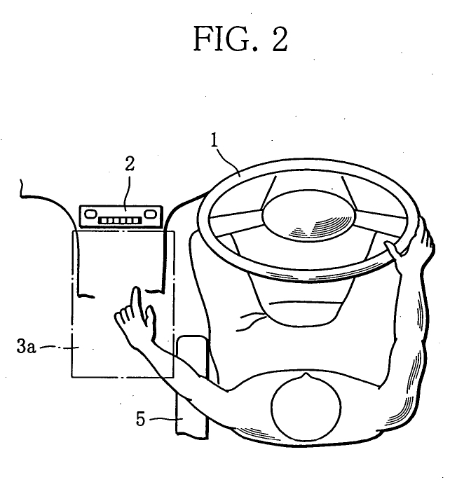

As shown in FIG. 2, the image pickup zone 3a of the camera 3 located laterally to the steering wheel 1 is at least 50 mm, preferably about 100 mm, apart from the outer periphery of the steering wheel 1. In particular, the image pickup zone is at a position to which the driver can extend the arm without changing a driving posture, while resting the arm on an arm rest 5 that is provided laterally to the driver's seat and which is located away from the operating section 2 for audio equipment, etc., so that the hand extended to the image pickup zone does not touch the operating section 2. The image pickup zone 3a is rectangle in shape and has a size of about 600 mm in a fingertip direction of and about 350 mm in a width direction of the driver's hand extended laterally to the steering wheel 1.

Specifically, the image pickup zone 3a is a zone that is set such that an image of the driver's hand is not picked up when the driver holds the steering wheel 1 or operates the combination switch (not shown) provided at the steering column shaft and such that the driver can move his/her hand into the zone without largely moving the arm. Thus, a hand motion for a driving operation or a hand/finger motion for a direct operation of the operating section 2 of the audio equipment, etc. is prevented from being erroneously detected as a motion for providing switch-operation information.

If a gearshift lever (not shown) is located in the image pickup zone 3a set as described above, a pressure-sensitive sensor for example may be provided in the gearshift lever to make a detection as to whether the gearshift lever is grasped by the driver. The provision of such sensor makes it possible to easily determine which of the gearshift lever or the hand pattern switch device is operated by the driver's hand extended to the image pickup zone 3a, whereby a driving operation is prevented from being erroneously detected as a switch operation. Alternatively, a height of driver's hand (i.e., distance from the camera 3) may be detected by using a stereoscopic camera serving as the camera 3, to determine whether the driver's hand extended to the image pickup zone 3a operates the gearshift lever or is present in a space above the gearshift lever.

The setting of the image pickup zone 3a is made based on a range (displacement width) of arm/hand motion to which the driver can naturally extend the arm without changing a driving posture while resting the arm (elbow) on the arm rest 5 and to which the driver can comfortably and naturally move the arm/hand when making the imaginary switch operation. In particular, by taking into account of a typical length from the wrist to the fingertip being about 200 mm and a typical hand width being about 120 mm, the image pickup zone 3a is determined to be a rectangle in shape and to have a 600 mm length and a 350 mm width, as mentioned above.

By setting the image pickup zone 3a as described above, the driver's hand coming off the steering wheel 1 and then naturally moved without a sense of incompatibility can be captured without fail and without a hand/arm motion for a driving operation being erroneously detected. It is also possible to reliably grasp a change in hand position or a hand motion for switch operation in the image pickup zone 3a, so that the hand pattern recognition and the detection of an amount of hand motion (deviation) can easily be made with relatively simplified image processing.

For the driver, he/she can perform a desired switch operation by simply moving the hand after forming a corresponding one of predetermined hand patterns, while extending the arm laterally to the steering wheel 1 without changing a driving posture and without directly touching the operating section 2 for audio equipment, etc. This reduces a load of the driver performing the switch operation. In addition, since a hand motion and/or an arm motion for a driving operation cannot erroneously be detected as instruction for switch operation, there are advantages that the driver can concentrate on driving without paying attention to the hand pattern switch device, and can, where required, easily give instruction for switch operation by simply moving his/her hand (palm) to the image pickup zone 3a.

The following is the description of the hand recognition processing, which is one of the features of this invention and which is performed based on the binary image.

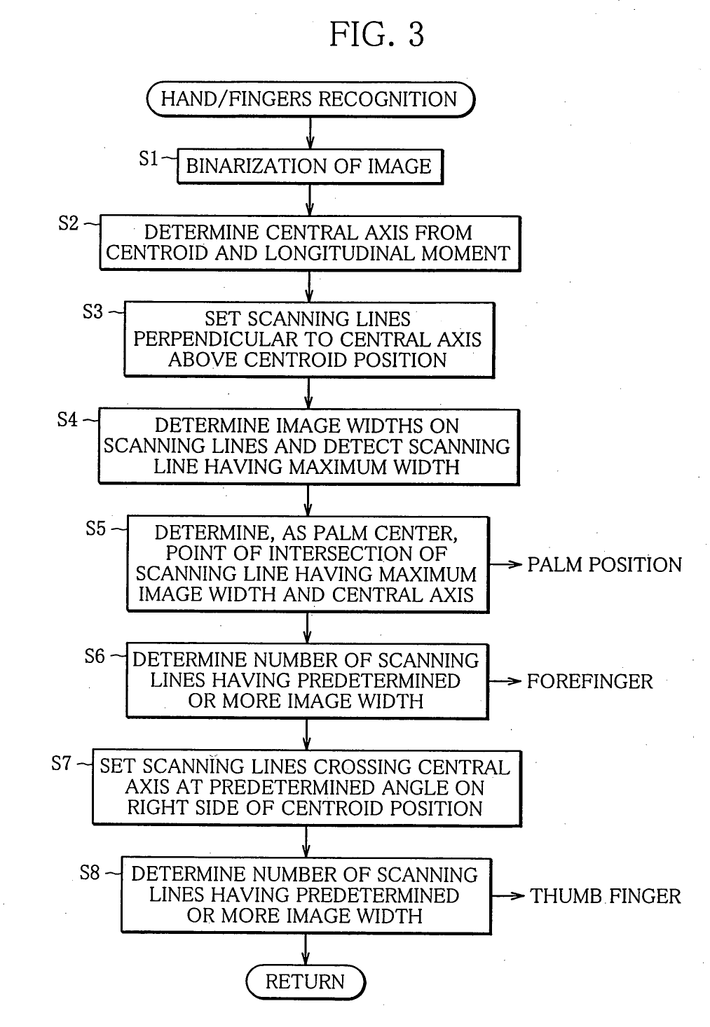

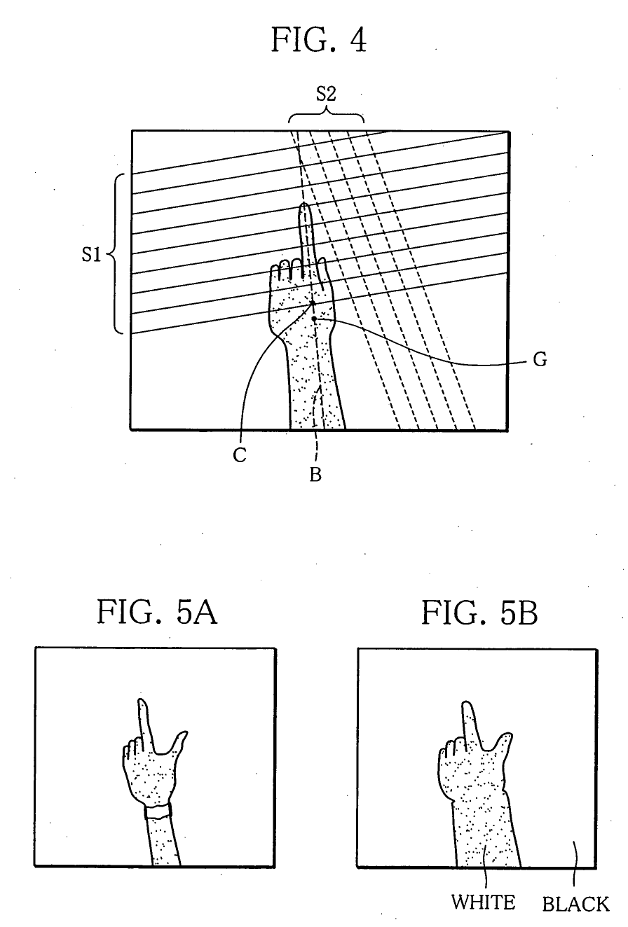

Referring to processing procedures shown in FIG. 3, at start of the recognition processing, an input image of the pickup zone 3a picked up by the camera 3 is subject to binarization processing using a predetermined threshold value, whereby the background of the image is discriminated as black from other portions of the image, as white, corresponding to the arm and palm (step S1). By means of the binarization processing, a binarized image of the pickup zone 3a is obtained as exemplarily shown in FIG. 4. Next, the centroid G of the white region of the binarized image, corresponding to image components of the arm and palm, is determined. Then, a central axis B is determined from the centroid G and a longitudinal moment that is determined by analyzing the direction in which white elements are present passing through the centroid G (step S2). By determining the central axis B passing through the centroid G of the white region in this manner, the position of the central axis B can accurately be set.

Subsequently, a plurality of first scanning lines Si extending at right angles with respect to the central axis B are set at equal intervals between an upper side or fingertip side of the binarized image and the centroid G (step S3). Then, widths W of the white image on the respective scanning lines S1 are determined in sequence from the upper side of the binarized image, to thereby detect the scanning line Si which is maximum in the white image width W (step S4). At this time, it is preferable that only the white image, which is continuous on the both sides of the central axis B, be selected as the detection object in detecting the white image width W on each scanning line S1. As for the detection of the scanning line S1 that is maximum in white image width W, a determination is made whether or not the white image width W detected sequentially from the upper side of the image is larger than that detected on the immediately preceding scanning line S1, and when a peak appears in the detected widths, the associated scanning line S1 is detected as the one having the maximum white image width.

Next, a point of intersection of the thus detected scanning line S1 having the maximum white image width W and the central axis B is detected as a palm center position C (step S5). By doing the above processing to determine the palm center position C, it is possible to accurately determine the palm center position C since the width on the wrist side is generally narrower than the width of a central portion of palm, even when the binarized image is disconnected at a portion (wrist portion) between the arm and palm as shown in FIG. 5A due to the presence of a watch or a wrist band attached to the wrist or even when the size (width) of arm, especially the size of the wrist portion, is detected to be extraordinarily large as shown in FIG. 5B for the reason that the wrist is hidden by a long-sleeve cloth which the driver wears.

Subsequently, on the basis of the palm center position C and the palm width W determined as mentioned above, among the scanning lines S1 located between the upper side of the binarized image and the center position C, a number of scanning lines S1 for each of which a width equal to or larger than the predetermined width w has been detected is determined (step S3). More specifically, an examination is made whether the width detected on each scanning line S1 is equal to or larger than the predetermined width w that is set to a value of 1/7 to ¼ of the maximum width W at the palm center position C. Then, a determination is made whether the number of scanning lines S1, for which a white image whose width is equal to or larger than the predetermined width w has been detected, is equal to or larger than a value that is set beforehand in accordance with the spacing between the adjacent scanning lines S1. If there is a white image region extending by a predetermined length or more in the direction of the central axis B, the white image region is detected as a finger (forefinger, for instance) extended from the palm. For example, if the length measured from the palm center position C, which is detected in terms of the number of the scanning lines S1 as mentioned above, is 10 cm or more, it is detected that the forefinger is extended from the palm.

The thumb finger can be detected in a similar manner. Since the detection object is the left hand and the thumb finger is extended in a direction different from the direction in which the forefinger is extended, second scanning lines S2 used to detect the thumb finger are set on the right side of the palm center position C so as to be inclined at an angle of about 10 degrees relative to the central axis B (step S7). This setting is based on the fact that the thumb finger extends slightly obliquely with respect to the central axis B when it is extended to be opened at the maximum. By setting the second scanning lines S2 such that the thumb finger opened at the maximum extends substantially perpendicular to the scanning lines S2, a reliable detection of the thumb finger can be achieved.

Next, a determination is made as to how many number of scanning lines S2 are present for each of which a width equal to the predetermined width w or more has been detected, among the scanning lines S2 located between the right side of the binarized image and the center position C (step S8). At this time, as in the case of the detection of the forefinger, a determination is made whether the number of scanning lines S2 for which a white image whose width is equal to or larger than the width w set to be 1/7 to ¼ of the maximum width W at the palm center position C has been detected is equal to or larger than a predetermined value. When the predetermined number or more of scanning lines S2 is detected, it is detected that the thumb finger is extended from the palm to the right side.

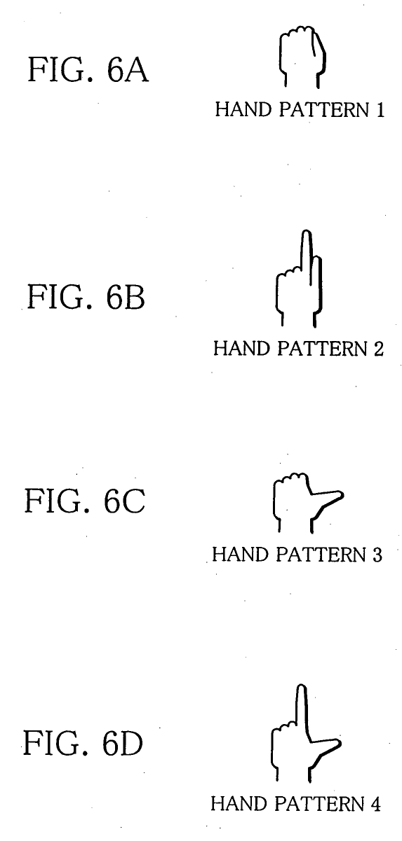

By means of the above-mentioned recognition processing, information can be determined that represents the hand pattern in the pickup zone 3a and the palm center position C. Then, determinations are made whether or not the forefinger is detected and whether or not the thumb finger is detected, thereby determining which pattern is formed among the following: a clenched-fist pattern (hand pattern 1) in which all the fingers are bent into the palm; a finger-up pattern (hand pattern 2) in which only the forefinger is extended; an acceptance (OK) pattern (hand pattern 3) in which only the thumb finger is extended horizontally; and an L-shaped pattern (hand pattern 4) in which the forefinger and the thumb finger are extended. These patterns are shown in FIGS. 6A-6D, respectively.

In this embodiment, the L-shaped pattern (hand pattern 4) is used to instruct the start of operation to the hand pattern switch device. The hand pattern 3 is used in combination of the clenched-fist pattern (hand pattern 1) to express image of depressing a push button, by changing the hand pattern by putting the thumb finger in and out (flexing). The hand pattern 3 is used to input information for selection of controlled objects. The finger-up pattern (hand pattern 2) is to express image of an indicating needle of an analog meter, and is used to instruct an amount of operation to the controlled object by changing the-position of fingertip (or palm). The clenched-fist pattern (hand pattern 1) is also used to instruct completion of operation of the hand pattern switch device.

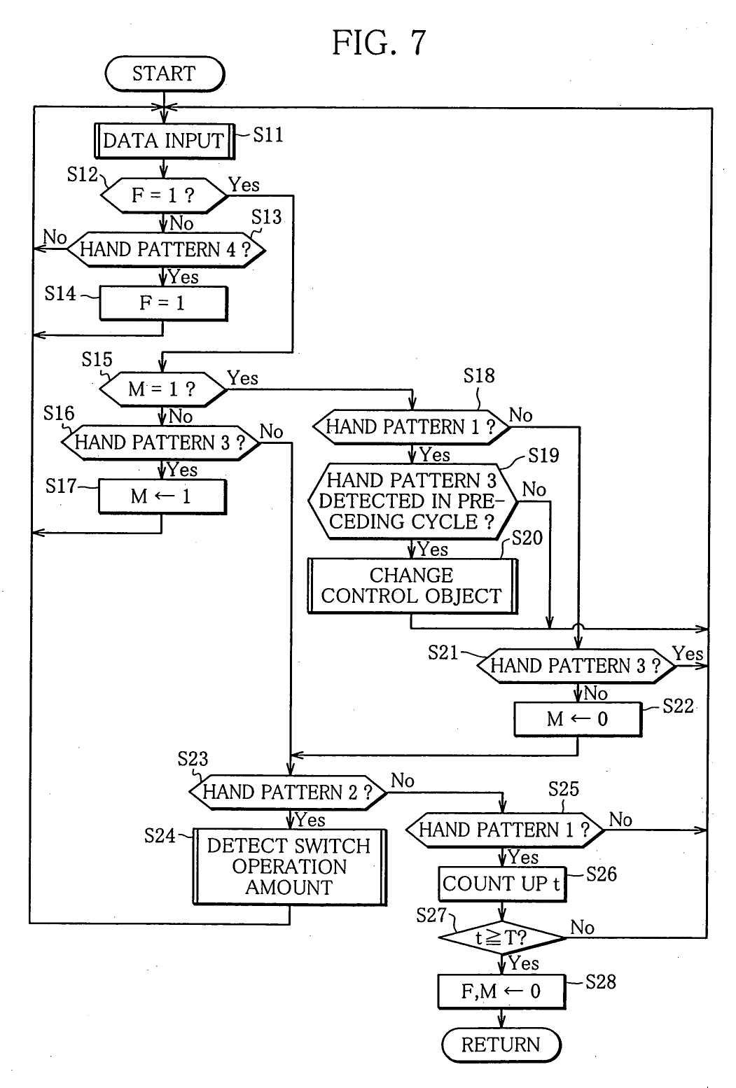

In the instructed-operation recognizing section 14, the hand pattern and the change in palm position recognized as mentioned above are subject to the recognition processing that is performed in accordance with procedures exemplarily shown in FIG. 7, whereby switch operations by means of the driver's (switch operator's) hand are interpreted and switch-operation information is output to the controlled objects.

More specifically, the instructed-operation recognizing section 14 inputs data representing results of recognition in the pattern recognition section 13 and information of palm center position C (step S11). Then, a flag F used to discriminate whether a switch operation is instructed is checked (step S12). If the flag F is not set (F=0), whether or not the hand pattern is the L-shaped pattern (hand pattern 4) instructing the start of operation is determined (step S13). When the hand pattern 4 is detected, the flag F is set (step S14), whereby the input of switch-operation information is started. If the hand pattern 4 is not detected, the aforementioned processing is repeatedly performed until the hand pattern 4 is detected.

If the flag F is set (F=1), it is determined that the input processing for the switch operation is already started (step S12). Thus, a determination is made in respect of a flag M that is used to discriminate whether a function selection mode for specifying a controlled object is set (step S15). If the flag M is not set (M=0), whether the hand pattern is the hand pattern 3 used to select a controlled object is determined (step S16). If the hand pattern 3 is determined, the flag M is set to 1 (M=1), thereby setting the controlled object selection mode (step S17). If the hand pattern 3 is not determined, the later-mentioned processing to input a switch operation amount is executed, determining that a controlled object is already specified.

In case that the hand pattern 3 is detected and the controlled object selection mode is set, whether or not the hand pattern is the clenched-fist pattern (hand pattern 1) is then determined (step S18). If the hand pattern 1 is detected, whether the immediately precedingly detected hand pattern was the hand pattern 3 is determined (step S19). When the change from the hand pattern 3 to the hand pattern 1 is detected, the controlled object is changed, considering that the change in hand pattern is the instruction to make changeover of the controlled objects (step S20). As for the change in controlled object, there may be a case where controlled objects are three, one for sound volume in audio equipment, one for temperature in air conditioner, and one for wind amount in air conditioner. In such a case, these controlled objects may be cyclically changed over as mentioned later.

Meanwhile, even when the hand pattern 1 is detected in the present cycle, if the hand pattern in the immediately preceding cycle was not the hand pattern 3 (step S19), the processing from step S11 is resumed, considering that the changeover from the hand pattern 3 to the hand pattern 1 is not performed in the controlled object selection mode. If the hand pattern 1 is not detected at step S18, whether or not the detected hand pattern is the hand pattern 3 is then determined (step S12). If the detected hand pattern is the hand pattern 3, the processing from step S11 is resumed, considering that the hand pattern 3 remains unchanged in the controlled object selection mode. If the detected hand pattern is neither the hand pattern 1 nor the hand pattern 3 (steps S18 and S21), the flag M is reset to 0 (M=0), the controlled object selection mode set as mentioned above is released.

If the hand pattern 3 is not detected in a state where the controlled object selection mode is not set (step S16), or if the controlled object selection mode is released (step S22), whether or not the hand pattern is the finger-up pattern (hand pattern 2) with only the forefinger extended is determined (step S23). When the hand pattern 2 is detected, the below-mentioned processing to detect the switch operation amount is carried out (step S24). If the hand pattern 2 is not detected at step S23, whether or not the hand pattern is the clenched-fist pattern (hand pattern 1) is determined (step S25). In the case of the hand pattern 1, a timer t is counted up (step S26), and whether or not a predetermined time T has elapsed is determined referring to the counted-up timer t (step S27). If the hand pattern 1 is maintained for the predetermined time T or more, the flags F and M are reset to 0 (F=0, M=0), and the aforementioned series of processing is completed, considering that the completion of switch operation is instructed (step S28). If the hand pattern is neither the hand pattern 2 nor the hand pattern 1 (steps S23 and S25), the processing from step S11 is resumed to await for the next instruction being input. If the hand pattern 1 is not maintained for the predetermined time T or more, that is, if the hand pattern is changed to the hand pattern 2 again within the predetermined time T (step S27), the processing from step S11 is resumed, making it possible to perform reoperation.

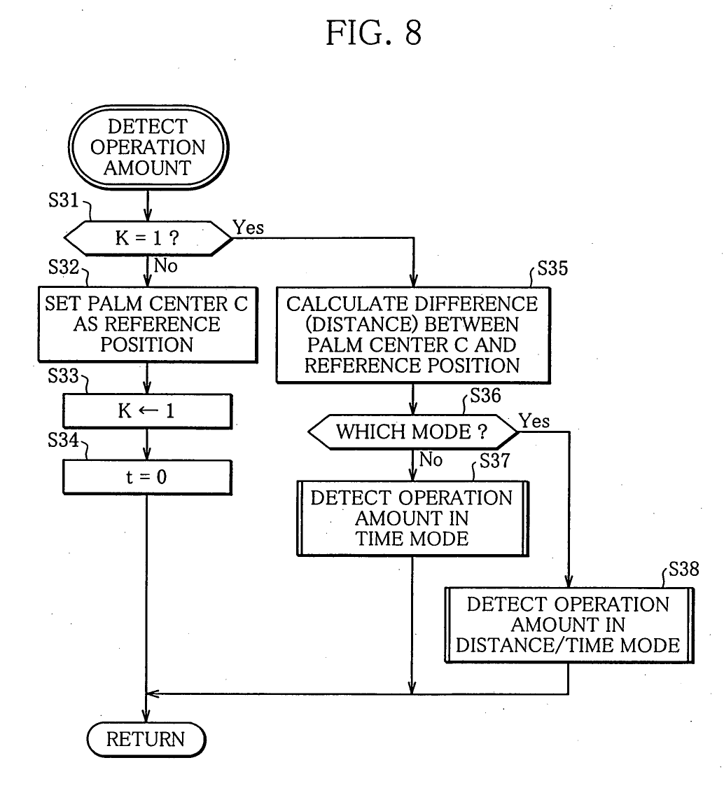

The following is a concrete explanation on the processing to detect the switch operation amount in response to the finger-up pattern (hand pattern 2). Such processing is generally performed in accordance with processing procedures shown in FIG. 8. At start of the processing to detect the switch operation amount, whether or not a flag K used to identify whether the operation amount setting mode is set is determined (step S31). If the operation amount setting mode is not set (K=0), the palm center position C determined as mentioned above is set as a reference position C₀ for the operation amount detection (step S32). Next, the flag K is set to 1 (K=1) to thereby set the operation amount setting mode (S33), and a timer value t used in the operation amount setting mode is reset to 0 (step S34).

As for data subsequently input, it is determined that the flag K is set (step S31), and therefore, the distance of deviation between the palm center position C determined at that time and the reference position C₀, i.e., a moved distance D from the reference position C₀, is determined (step S35). In order to calculate the moved distance D, it is enough to determine a distance between picture elements in the input image. In accordance with the moved distance thus determined and predetermined modes for the detection of operation amount (S36), processing to detect the operation amount is selectively carried out in a time mode (step S37) or in a distance/time mode (step S38).

The time mode is a mode in which switch-operation information is output in accordance with a stop time for which the hand displaced from the reference position C₀ is kept stopped, and is suitable for example for adjustment of sound volume in audio equipment and for adjustment of temperature in air conditioner. The distance/time mode is a mode in which the switch-operation information determined according to an amount of hand motion is output when the hand is moved slightly, whereas the information determined according to a stop time of the hand at a moved position is output when the hand has been moved by a predetermined distance or more to the moved position. The distance/time mode is suitable for example for controlled objects that are subject to a fine adjustment after being roughly adjusted.

In this embodiment, the instruction to input the switch operation amount by means of the finger-up pattern (hand pattern 2) is carried out by moving the palm to the right and left around the arm on the arm rest 5 or by moving the hand right and left around the wrist as fulcrum. Such palm/hand motion to the right and left is performed within a range not falling outside of the pickup zone 3a, for instance, within an angular range of about ±45 degrees. To be noted, in this embodiment, the amount of palm motion with the hand pattern 2 is detected n steps.

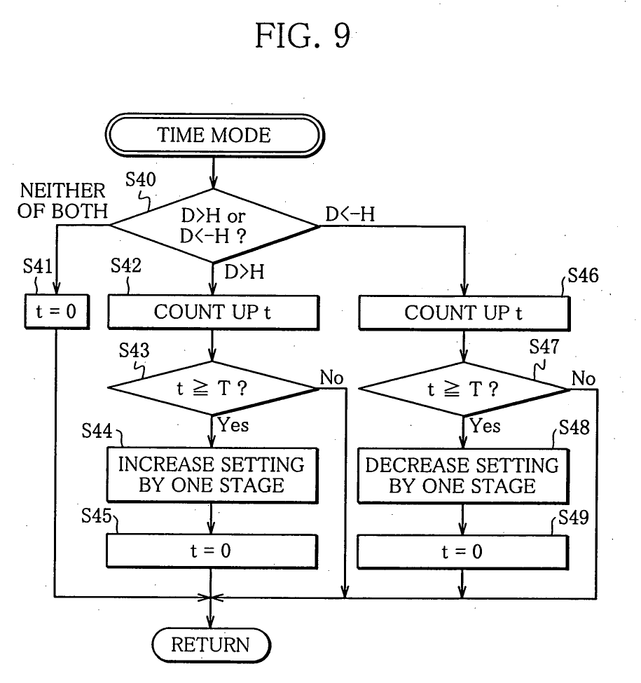

Referring to FIG. 9 exemplarily showing the processing procedures for the detection of operation amount in the time mode, a determination is first made to determine whether or not a motion amount D measured from the reference palm position C₀ has exceeded a preset value (threshold value) H or −H used for determination of maximum motion amount (step S40). If the moved distance D does not reach the preset value (threshold value) H or −H, a timer value t is set to 0 (step S41). Whereupon the processing starting from step S11 is resumed.

If it is determined at step S40 that the moved distance D exceeds the preset value (threshold value) H, the timer value t is counted up (step S42). When the counted-up timer value t reaches a reference time T (step S43), the setting (switch-operation information) at that time is increased by one stage (step S44). Then, the timer value t is reset to 0 (step S45), and the processing from step S11 is resumed.

If it is determined at step S40 that the moved distance D exceeds the threshold value −H in the opposite direction, the timer value t is counted up (step S46). When it is determined that the counted-up timer value t reaches the reference time T (step S47), the setting (switch-operation information) at that time is decreased by one stage (step S48). Then, the timer value t is reset to 0 (step S49). Whereupon, the processing from step S11 is resumed. By means of such a series of processing, when the palm with forefinger-up has moved left and right by the predetermined distance and stops there, the operation information (set value) for the controlled object is increased or decreased one stage by one stage in accordance with the stop time, and the switch-operation information is output.

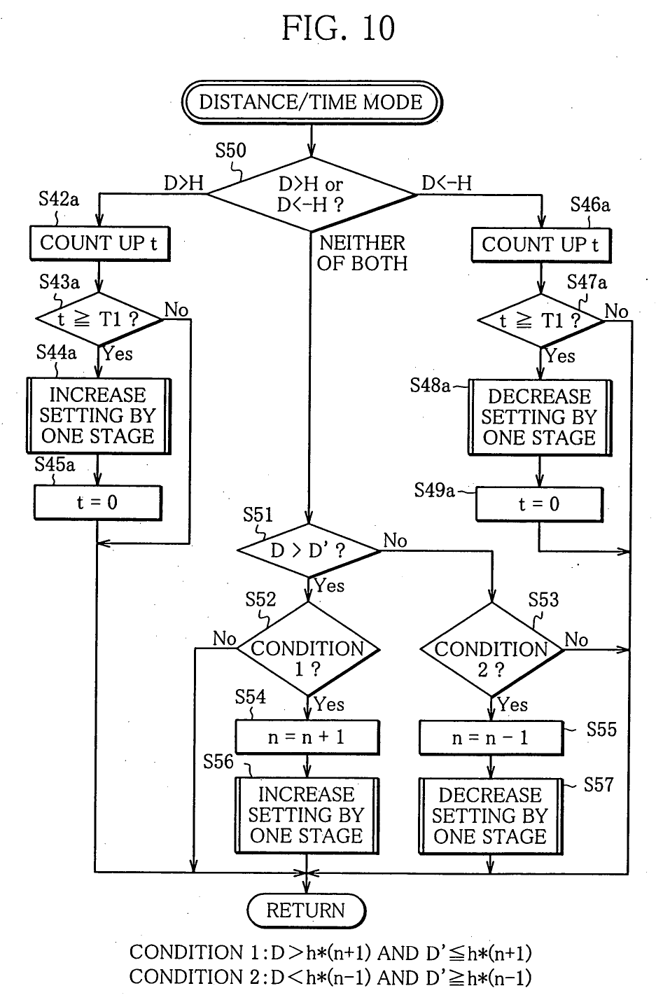

Referring to FIG. 10 exemplarily showing the processing procedures for the detection of operation amount in the distance/time mode, a determination is first made to determine whether or not a motion amount D measured from the reference palm position C₀ has exceeded a preset value (threshold value) H or −H used for determination of maximum motion amount (step S50). If the determination threshold value H or −H is exceeded, the operation information (set value) for the controlled object is variably set in accordance with the stop time of the palm with forefinger-up at the maximum moved position, as shown in steps S42a-S45a and steps 46a-49a, as in the case of the time mode.

If it is determined at step S50 that the moved distance D of the palm from the reference position C₀ does not reach the maximum motion amount, the currently and immediately precedingly detected moved distances D and D′ are compared with each other, to thereby determine the direction of motion of the palm with forefinger-up (step S51). If the direction of motion is the increasing direction, whether or not condition 1 is satisfied is determined. Specifically, a determination is made as to whether the currently detected moved distance D from the reference position C₀ is larger than a detection distance [h*(n+1)] defined as integral multiple of a predetermined unit distance h and at the same time the immediately precedingly detected moved distance D′ is equal to or less than the just-mentioned detection distance (step S52). The n is a parameter used for setting the detection distance. If the palm currently moves in the increasing direction beyond the detection distance [h*(n+1)] used for determination and if the preceding moved distance D′ is equal to or less than the detection distance, that is, if the palm moves by a predetermined distance or more in the increasing direction from the preceding cycle to the present cycle so that condition 1 of D >h*(n+1) and D′ I h*(n+1) is fulfilled, the parameter n is incremented to set the detection distance for the next determination (step S54), whereby the operation information (setting) for the controlled object is increased by one stage (step S56).

If the direction of motion determined at step S51 is the decreasing direction, whether or not condition 2 is satisfied is determined. Specifically, a determination is made as to whether the currently detected moved distance D from the reference position C₀ is smaller than a detection distance [h*(n−1)] defined as integral multiple of the predetermined unit distance h and the immediately precedingly detected moved distance D′ is equal to or larger than the detection distance (step S53). If the palm currently moves in the decreasing direction beyond the detection distance [h*(n−1)] used for determination and if the preceding moved distance D′ is equal to or larger than the detection distance, that is, if the palm moves by the predetermined distance or more in the decreasing direction from the preceding cycle to the present cycle so that condition 2 of D<h*(n−1) and D′≧h*(n−1) is fulfilled, the parameter n is decremented to set the detection distance for the next determination (step S55), whereby the operation information (setting) for the controlled object is decreased by one stage (step S57).

With the operation-amount detection processing according to the distance/time mode, it is possible to substantially continuously afford the switch-operation amount in accordance with the moved distance D of the palm with the forefinger up that is measured from the reference position C₀. When the palm with the forefinger up is largely moved, the switch-operation amount can continuously be changed in accordance with a stop time of the palm at a stop position. Thus, in accordance with the palm or hand motion, the switch-operation amount can be set immediately. In addition, the switch-operation amount can be set finely, where required.

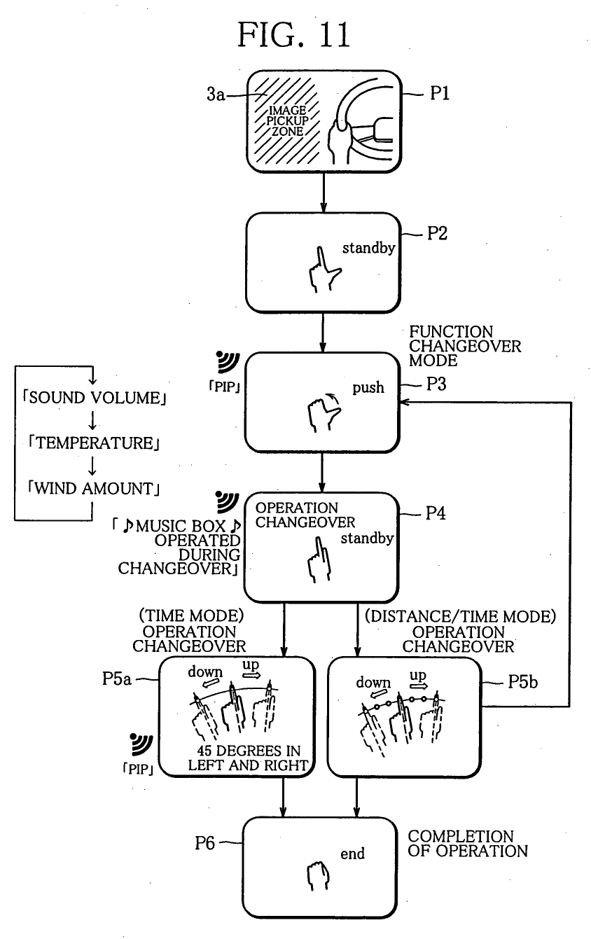

By using the instructed-operation recognizing section 14 which detects the hand/finger pattern and the palm motion to thereby identify the intention of the driver's (switch operator's) switch operation, switch information for various controlled objects can be input by simply forming a predetermined hand pattern and moving the hand and/or palm as exemplarily shown in FIG. 11, without the need of touching the operating section 2 of audio equipment, air conditioner equipment, etc.

Specifically, when the driver grasps the steering wheel 1 to drive the vehicle, driver's hands fall outside the image pickup zone 3a as shown by initial state P1. The input image at that time only includes image components that will be removed as merely representing the background of the vehicle compartment, so that the hand pattern switch device does not operate. On the other hand, when a driver's hand coming off the steering wheel 1 and then formed into an L-shaped pattern (hand pattern 4) enters the image pickup zone 3a as shown by operation state P2, it is determined that the hand pattern switch device is instructed to start operation. After outputting confirmation sound such as pip tone, the hand pattern switch device enters a standby state.

Subsequently, when the pattern (hand pattern 3) in which only the thumb finger is extended horizontally is set as shown by operation state P3, such pattern is detected and the function changeover mode (controlled object selection mode) is set. At this time, in order to notify the driver of the function changeover mode being set, a sound message is sent or a music box is operated. During this time, when the thumb finger is bent into the palm to form the clenched-fist pattern (hand pattern 1), it is determined that a push button switch operation is instructed, and the controlled object is changed over. At the time of controlled object changeover, speech guidance (speech message) may be notified such that “sound volume adjustment mode is set,” “temperature adjustment mode is set,” or “wind amount adjustment mode is set” each time a switch operation such as sound volume, temperature, wind amount is detected as mentioned above. More simply, the word such as “sound volume,” “temperature,” “wind amount” may be notified as speech message. Such guidance makes it possible for the driver to recognize a state of switch operation without the need of visually confirming the switch operation, whereby the driver is enabled to concentrate on driving.

After the desired controlled object is set, the finger-up pattern (hand pattern 2) is formed as shown in operation state P4. In response to this, the hand pattern 2 is recognized, and the operation amount setting mode is set. By taking into account of the predetermined operation modes, the palm with the finger-up pattern (hand pattern 2) is moved left and right as shown in operation state P5a or P5b, whereby switch-operation amount information for the controlled object set as mentioned above is input. When the desired switch operation is completed, the clenched-fist pattern (hand pattern 1) is formed as shown in operation state P6, whereby instruction to indicate the completion of operation is given to the hand pattern switch device.

During the course of moving the palm with finger-up pattern (hand pattern 2) left and right to input the switch-operation amount information, if the pattern (hand pattern 3) in which only the thumb finger is horizontally extended is formed, the processing to input the switch-operation amount information is completed at that time. In this case, processing for controlled object selection/changeover and subsequent processing can be performed again. Therefore, even in a case where a plurality of controlled objects are sequentially operated, continuous and repeated operations for the controlled objects can be carried out, without the recognition processing being interrupted. This makes it easy to perform operation.

With the hand pattern switch device constructed as mentioned above, switch-operation instructions based on the predetermined hand patterns and motions can easily and effectively be detected with reliability and without being affected by hand/finger motions and arm motions for a driving operation, and in accordance with detection results, switch-operation information can properly be provided to the desired vehicle-mounted equipment. The driver's load in operating the hand pattern switch device is reduced or eliminated since the region (image pickup zone 3a), in which an image of hand/fingers to give switch-operation instructions is picked up, is located at a position laterally to the steering wheel 1 and is set such that the driver can naturally extend the arm to this region without changing a driving posture. The hand patter switch device can achieve practical advantages such as for example that the driver can easily input instructions or switch-operation information through the use of the hand pattern switch device, with the feeling of directly operating the operating section 2 of audio equipment, etc.

In particular, according to the hand pattern switch device, the central axis extending toward the fingertip is determined from a binarized image of the palm, finger widths of the hand on scanning lines extending approximately perpendicular to the central axis are sequentially determined, and a point of intersection of the central axis and a scanning line which is maximum in finger width is determined as palm center. This makes it possible to detect a palm portion in the binarized image with reliability. Even when the operator wears a long sleeve shirt and/or a wrist watch or the like, the palm center and the palm portion can reliably be detected, without being affected by image components corresponding to the shirt, etc.

According to the hand pattern switch device, scanning lines for finger-detection are set in the direction perpendicular to the extending direction of a finger to be detected, and an image component for which a width equal to or larger than a predetermined width is detected on each scanning line is determined as a finger width. Whether or not the finger is extended from the palm is then determined based on the number of scanning lines on which the predetermined or more finger width is detected. Therefore, a finger pattern can easily and reliably be recognized (detected). In particular, by determining extended states of the forefinger and thumb finger from the palm by positively utilizing a difference between directions in which these fingers can be extended, individual features of the hand patterns can be grasped with reliability in the hand pattern recognition. This makes it possible to surely recognize the hand pattern and the palm motion (positional change) even by means of simplified, less costly image processing, resulting in advantages that operations can be simplified, and the like.

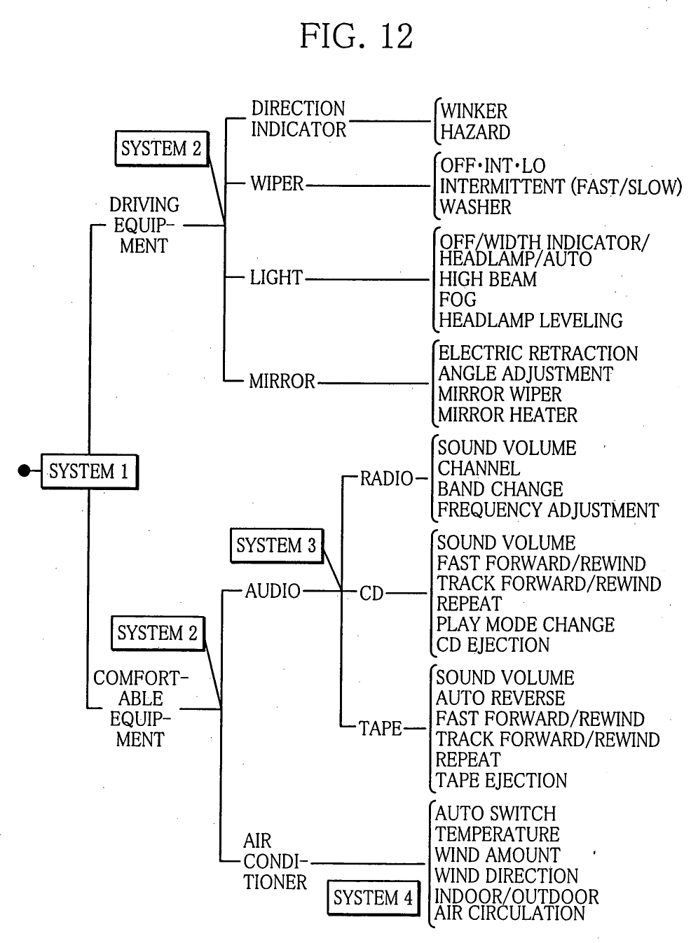

The present invention is not limited to the foregoing embodiment. In the embodiment, explanations have been given under the assumption that this invention is applied to a right-steering-wheel vehicle, but it is of course applicable to a left-steering-wheel vehicle. This invention is also applicable to an ordinary passenger car other than a large-sized car such as truck. As for the controlled object, expansions can be made to operation of wiper on/off control, adjustment of interval of wiper operation, side mirror open/close control, etc., as exemplarily shown in FIG. 12. In this case, the controlled objects are systematically classified in the form of tree structure in advance, so that a desired one of these controlled objects may be selected stepwise.

Specifically, the controlled objects are broadly classified into driving equipment system” and “comfortable equipment system.” As for the driving equipment system, it is divided into medium classes as “direction indicator,” “wiper,” “light” and “mirror.” Functions of each of the controlled objects belonging to the same medium class are further divided into narrow classes. Similarly, the comfortable equipment system is divided into medium classes as “audio” and “air conditioner.” As for the audio, it is classified into types of equipment such as “radio,” “CD,” “tape,” and “MD.” Further, each type of equipment is classified into functions such as operation mode and sound volume. From the viewpoint of easy operation, in actual, the setting is made such that only the necessity minimum controlled objects are selectable because the selection operation becomes complicated if the setting is made to include a large number of classes.

Of course, the hand patterns used for information input are not limited to those described by way of example in the above. In other respects, this invention may be modified variously, without departing from the scope of invention.

According to the thus constructed hand pattern switch device, a finger of a hand is detected through the use of first scanning lines set to extend perpendicular to the central axis extending from an arm portion to a fingertip in a binarized image and/or second scanning lines set to extend along the central axis. It is therefore possible to reliably detect whether or not a finger of the hand is extended, without being affected by image components corresponding to a long sleeve shirt, a wrist watch, etc., that are sometimes worn by the operator. Thus, the hand pattern can be determined with accuracy. In particular, the central axis is determined as passing through the palm center, and a finger width equal to or larger than 1/7 to ¼ of an image width detected on a scanning line passing through the palm center is detected, to thereby make a determination whether or not a forefinger or a thumb finger is extended. Thus, the finger pattern can easily and reliably be recognized (detected).

As a consequence, the hand pattern and the hand motion can be recognized with reliability, while reducing the load of the recognition processing, in which the hand pattern and/or the palm (fingertip) motion is detected and switch-operation information is given to various controlled objects.

1. A hand pattern switch device having image pickup means for picking up an image of a distal arm that is within a predetermined image pickup zone, and detecting a hand pattern and/or a motion of a finger of a hand from the image picked up by the image pickup means to obtain predetermined switch operation information, comprising:
first image processing means for determining a central axis passing through a center of the arm based on the picked-up image;
scanning line setting means for setting at least either a first scanning line extending perpendicular to the central axis or a second scanning line extending along the central axis; and
determination means for determining whether or not any finger of the hand is extended based on the at least either the first or second scanning line set by the scanning line setting means.

2. The hand pattern switch device according to claim 1, wherein said determination means includes function selection means for detecting projection and withdrawal of a particular finger of the hand and for cyclically selecting and specifying one of the controlled objects each time when the projection or withdrawal of the particular finger is detected, and equipment operation means for providing a control amount for the controlled object specified by said function selection means in accordance with a predetermined hand pattern and/or a motion of the hand with such hand pattern.

3. The hand pattern switch device according to claim 2, wherein said equipment operation means varies the control amount to be provided to the controlled object in accordance with an amount of hand motion from a reference position to right and left and/or a stop time at a destination of motion.

4. The hand pattern switch device according to claim 2, wherein said function selection means and said equipment operation means are caused to stop selecting and specifying the one of the controlled objects and to stop providing the control amount to the controlled object when said determination means detects that a clenched-fist pattern in which all fingers are bent into a palm is maintained for a predetermined time or more, and determines that completion of operation is instructed.

5. The hand pattern switch device according to claim 2, wherein said predetermined hand pattern includes a clenched-fist pattern in which all fingers are bent into a palm, a finger-up pattern in which only a forefinger is extended, a pattern in which only a thumb finger is extended horizontally, and an L-shaped pattern in which the forefinger and the thumb finger are extended.

6. The hand pattern switch device according to claim 2, wherein said particular finger is a thumb finger, said predetermined hand pattern is a finger-up pattern in which only a forefinger is extended, and said equipment operation means detects a left and right motion of the finger-up pattern.

7. The hand pattern switch device according to claim 1, wherein said image pickup means is a camera installed at a ceiling above a driver's seat of a vehicle.

8. The hand pattern switch device according to claim 2, further comprising a guidance function to provide confirmation sound when one of the controlled objects is selected by said function selection means.

9. The hand pattern switch device according to claim 7, wherein said image pickup zone is located at a position to which a driver can extend his/her arm without changing a driving posture while resting the arm on an arm rest provided laterally to the driver's seat of the vehicle and without a driver's hand being touched to an operating section of a console provided in the vehicle.

10. The hand pattern switch device according to claim 1, wherein said image processing means includes a binarization processing means for subjecting the picked-up image to binarization processing, and centroid detecting means for determining a centroid of the picked-up image having been subject to the binarization processing, and
the central axis passing through the center of the arm in the image is determined as an axis passing through the centroid of the image.

11. The hand pattern switch device according to claim 10, wherein the first scanning line is set in plural numbers between a side of the distal arm and the centroid, and
second image processing means is provided which determines a scanning line for which a width of the distal arm having been subject to the binarization processing becomes maximum, and determines a point of intersection between the just-mentioned scanning line and the central axis as a palm center.

12. The hand pattern switch device according to claim 1, wherein said scanning line setting means sets both the first and second scanning lines, and
said determination means determines whether or not a forefinger is extended by using the first scanning line, and determines whether or not a thumb finger is extended by using the second scanning line.

13. The hand pattern switch device according to claim 12, wherein said scanning line setting means sets the second scanning line to be inclined at an angle of about 10 degrees with respect to the central axis.

14. The hand pattern switch device according to claim 13, wherein said determination means determines that a finger of the hand is extended from the palm when a number of scanning lines for each of which a finger width equal to or larger than a predetermined width is detected is equal to or larger than a predetermined number.

15. The hand pattern switch device according to claim 14, wherein said predetermined width is 1/7 to ¼ or more of the width detected in the scanning line passing through the palm center.
